(19) United States
(12) Patent Application Publication
(10) Pub. No.: US 2016/0151899 A1
(43) Pub. Date: Jun. 2, 2016

(54) Anti-Slip Fastener Driver

(71) Applicant: New Way Tools Co., Ltd., Taichung City (TW)

(72) Inventor: Ping-Wen Huang, Taichung (TW)

(21) Appl. No.: 15/016,356

(22) Filed: Feb. 5, 2016

Related U.S. Application Data
(63) Continuation-in-part of application No. 13/949,300, filed on Jul. 24, 2013, now Pat. No. 9,308,628.

(30) Foreign Application Priority Data
May 28, 2013 (TW) 102118744

(51) Int. Cl. B25B 27/18; B25B 15/00

(52) U.S. Cl. CPC B25B 27/18; B25B 15/008

(57) ABSTRACT

An anti-slip fastener driver includes a driving portion formed at one terminal end of a body portion. The driving portion includes two driving sections and a middle arranged between the two driving sections. Each driving section forms a contact face which has a first included angle at 90 degrees to the peripheral face of the driving portion. Each contact face includes a long side connecting with a proximal face of the middle section. The long side of the contact face and the proximal face of the middle section include a second included angle at 90 degrees.

### CROSS REFERENCE TO RELATED APPLICATION

The present application is a continuation-in-part application of U.S. patent application Ser. No. 13/949,300 filed on Jul. 24, 2013, of which the disclosure is incorporated herein.

### BACKGROUND OF THE INVENTION

1. Field of the Invention

The present invention relates to a fastener driver and, in particular, to an anti-slip fastener driver that prevents or reduces the tendency of a driving portion to slip out of the head of a stripped screw.

2. Description of the Related Art

A screw is a threaded fastener that is used to attach a workpiece or help keep a workpiece in position. The screw has a head specially formed section on one end thereof and designed to fit a certain type of screw driver, which allows users to insert or remove the screw. A stripped or damaged screw is one on which the head is damaged and, thus, difficult or impossible to turn using conventional screw drivers. This damage of screws can occur through normal wear and tear, or by using the wrong type or size of driver for the screw.

Screws have several types of head designs, depending on the manner in which the screw is intended to be used. Some heads of the screws are more susceptible to stripping than others, particularly when being driven by machine-guided tools. The simplest and least expensive screws often are manufactured with slot heads, which can be driven with a variety of tools. These types of heads also are easily damaged if too much torque is applied, often leading to a stripped screw.

When a screw does become damaged, a user can attempt several methods to remove the stripped screw. If the stripped screw is made from a softer metal, then the user can try cutting a new slot in it with a rotary tool or removing the head of the screw with a power drill. However, it needs more tools for cutting a new slot in the stripped screw. Actually, that is too much trouble for users.

The present invention is, therefore, intended to obviate or at least alleviate the problems encountered in the prior art.

### SUMMARY OF THE INVENTION

The present invention solves this need and other problems in the field of fastener drivers adapted for driving a damaged fastener by providing an anti-slip fastener driver including a body portion and a driving portion formed at one terminal end of the body portion. The driving portion includes at least one peripheral face. At least one contact face is formed at one distal end of the driving portion opposite to the body portion. The at least one contact face is at a first included angle 90 degrees to the at least one peripheral face. The at least one contact face includes two contact faces. The driving portion includes two driving sections and a middle section arranged between the two driving sections. Each driving section has three peripheral faces. Two proximal faces are respectively formed in two opposite sides of the middle section. One end of each driving section opposite to the body portion forms the contact face. One end of the middle section opposite to the body portion has a spaced face. The two contact faces and the spaced face form an end face of the distal end of the driving portion together. Each of the two contact faces is flat and is at the first included angle equaling to 90 degrees to one of the three peripheral faces of each driving section. The spaced face is flat and is perpendicular to one of the peripheral faces of one of the driving section. Each of the two contact faces includes three short sides respectively connecting with the three peripheral faces of each driving section, and a long side connecting with one of the proximal faces of the middle section. The long side of each contact face and each side of the middle section form a second included angle at 90 degrees.

It is an object of the present invention to provide an anti-slip fastener driver adapted for driving a damaged or stripped fastener.

### BRIEF DESCRIPTION OF THE DRAWINGS

The illustrative embodiments may best be described by reference to the accompanying drawings where:

FIG. 1 shows a perspective view of an anti-slip fastener driver in accordance with a first embodiment of the present invention.

FIG. 2 is a partial, enlarged side view of the anti-slip fastener driver of FIG. 1.

FIG. 3 is a partial, bottom view of the anti-slip fastener driver of FIG. 1.

FIG. 4 is a cross-sectional view of the anti-slip fastener driver of FIG. 1, illustrating the anti-slip fastener driver inserting into a fastener.

FIG. 5 shows a partial perspective view of an anti-slip fastener driver in accordance with a second embodiment of the present invention.

FIG. 6 shows a side view of the anti-slip fastener driver of FIG. 2.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “inner”, “outer”, “side”, “end”, “portion”, “section”, “longitudinal”, “clockwise”, “counterclockwise”, and similar terms are used herein, it should be understood that these terms have reference only to the structure shown in the drawings as it would appear to a person viewing the drawings and are utilized only to facilitate describing the invention.

### DETAILED DESCRIPTION OF THE PREFERRED EMBODIMENTS

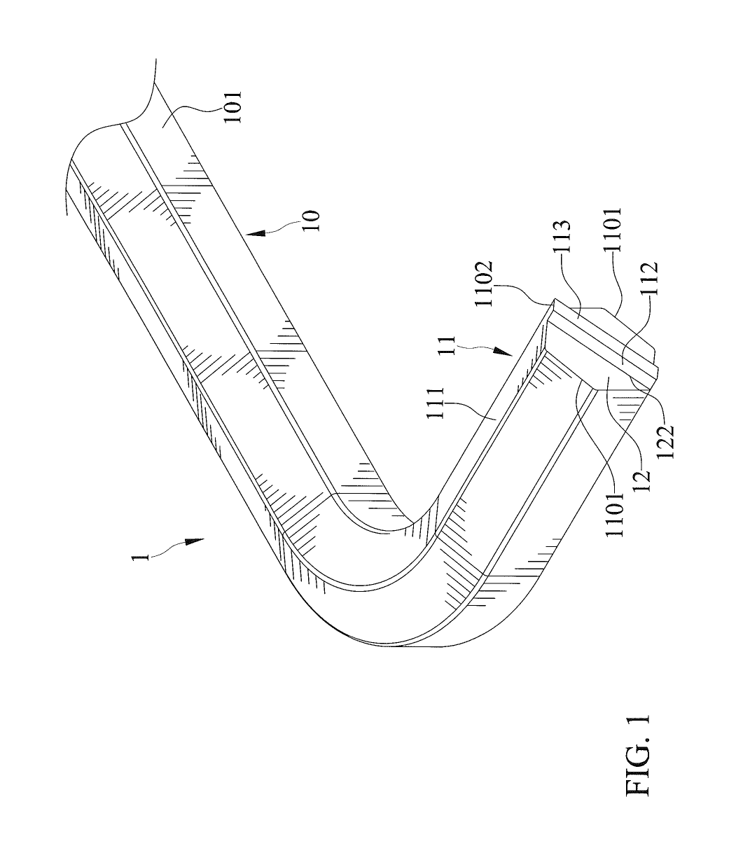

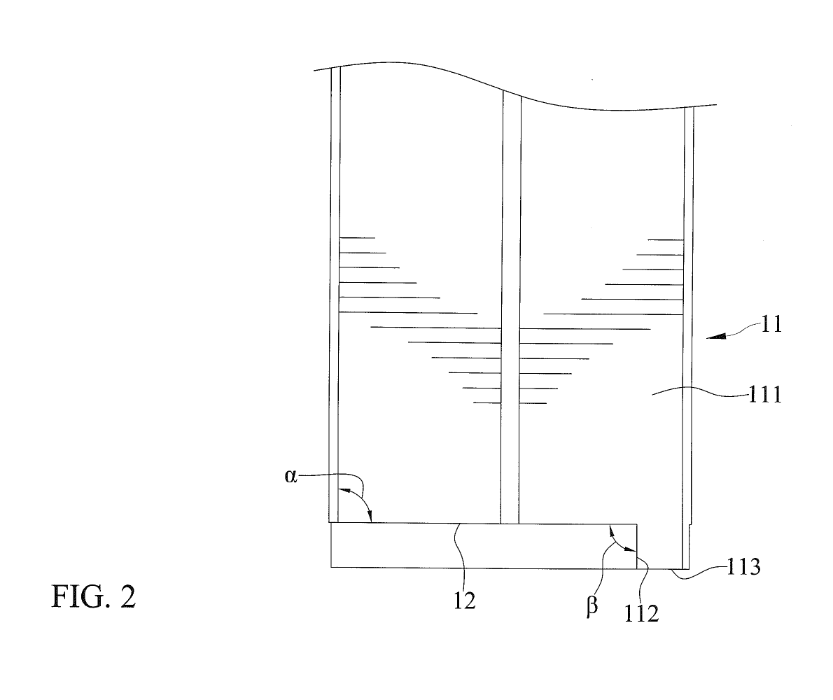

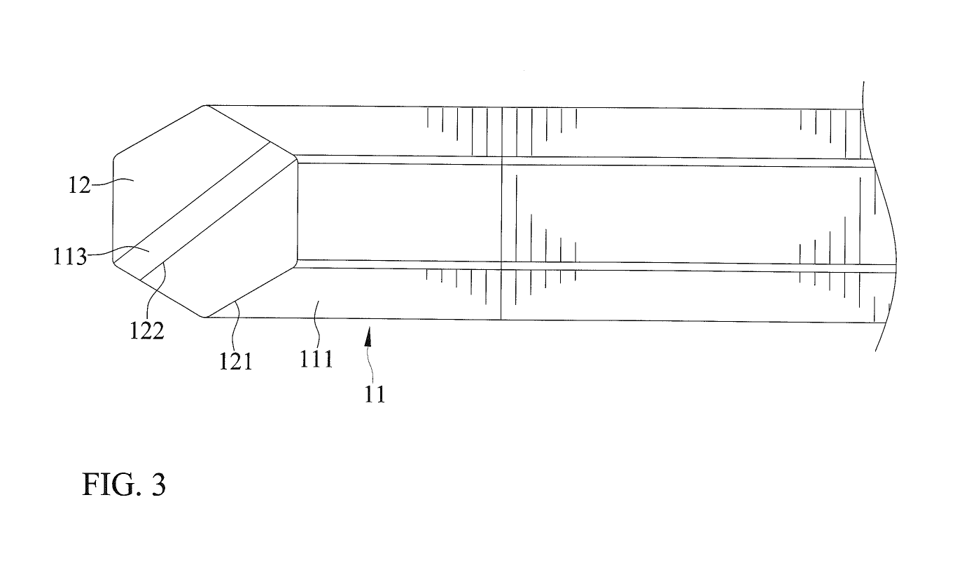

FIGS. 1 through 4 show an anti-slip fastener driver 1 in accordance with a first embodiment of the present invention. The anti-slip fastener driver 1 is applied in a hex key. The anti-slip fastener driver 1 includes a body portion 10 and a driving portion 11. The body portion 10 includes six outer walls 101. The driving portion 11 is formed at one terminal end of the body portion 10.

At least one contact face 12 is formed at one distal end of the driving portion 11 opposite to the body portion 10. The driving portion 11 includes at least one peripheral face 111. The at least one contact face 12 is at a first included angle α 90 degrees to the at least one peripheral face. The at least one contact face 12 include two contact faces 12. The driving portion 11 includes two driving sections 1101 and a middle section 1102 arranged between the two driving sections 1101. Each driving section 1101 has three peripheral faces 111. The driving portion 11 includes an outer periphery thereof defined by six peripheral faces of the two driving sections 1101. Two proximal faces 112 are respectively formed in two opposite sides of the middle section 1102. The middle section 1102 forms a protrusion and extends away from the two contact faces 12 to the distal end of the driving portion 11. One end of each driving section 1101 opposite to the body portion 10 forms the contact face 12. One end of the middle section 1102 opposite to the body portion 10 has a spaced face 113. The two contact faces 12 and the spaced face 113 form an end face of the distal end of the driving portion 11 together. Each of the two contact faces 12 is flat and is at the first included angle α equaling to 90 degrees to one of the three peripheral faces of each driving section 1101. The spaced face 113 is flat and is perpendicular to one of the peripheral faces 111 of one of the driving section 1101. Each of the two contact faces 12 includes three short sides 121 respectively connecting with the three peripheral faces 111 of each driving section 1101, and a long side 122 connecting with one of the proximal faces 112 of the middle section 1102. The long side 122 of each contact face 12 and each side of the middle section 1102 form a second included angle β at 90 degrees.

The two contact faces 12 and the spaced face 113 are parallel to one another.

The spaced face 113 is located at a first height with respect to one of the contact faces 12 and at a second height with respect to the other of the contact faces 12. The first height equals to the second height.

The body portion 10 extends from a first distal end of the anti-slip fastener driver 1 to the driving portion 11 in a first lengthwise direction and the driving portion 11 extends from the body portion 10 to the second distal end of the anti-slip fastener driver 1 in a second lengthwise direction, and wherein the first lengthwise direction is angled and not axial to the second lengthwise direction.

The middle section 1102 has a first end, a second end, and a longitudinal length extending from the first end to the second end thereof. The middle section 1102 includes the longitudinal length thereof extending from one of the three short sides 121 towards the first distal end of the body portion 10 to another of the three short sides 121 of the related contact face 12.

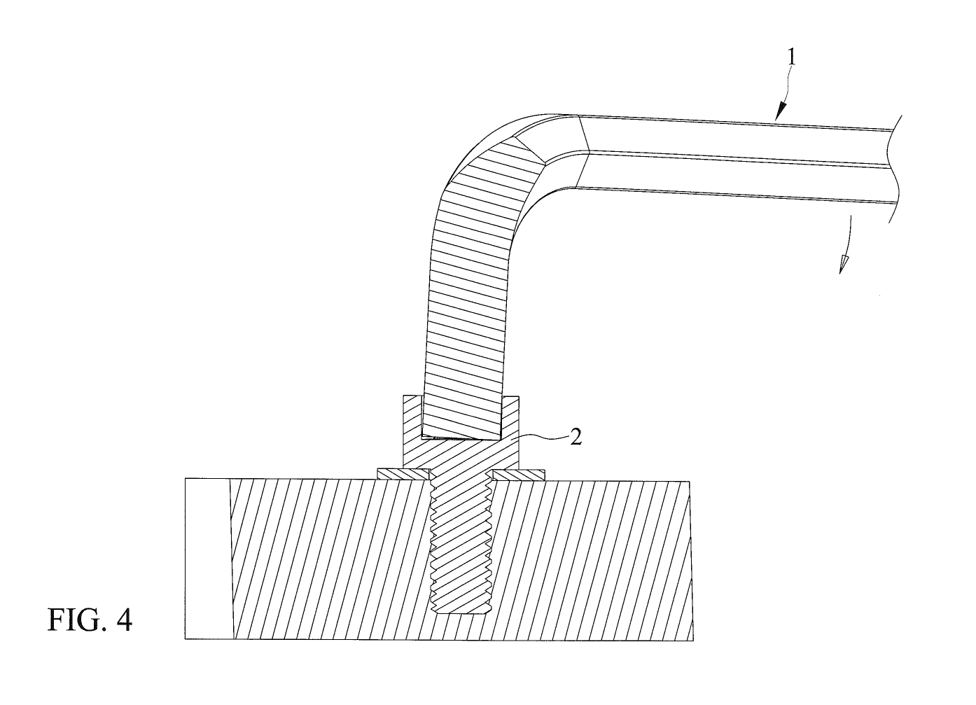

As such, when the anti-slip fastener driver 1 is operated to rotate a stripped the body portion 10 is moved in a direction as indicated by the arrow to make the second end of the middle section 1102, which is proximal to the first distal end of the body portion 10, “bite” downwardly into a base of a hole of a stripped screw to be driven, as shown in FIG. 4, thereby attaining enough grip force to rotate the stripped screw. In addition, the first end of the middle section 1102 bite upwardly into a peripheral wall of the hole of the stripped screw.

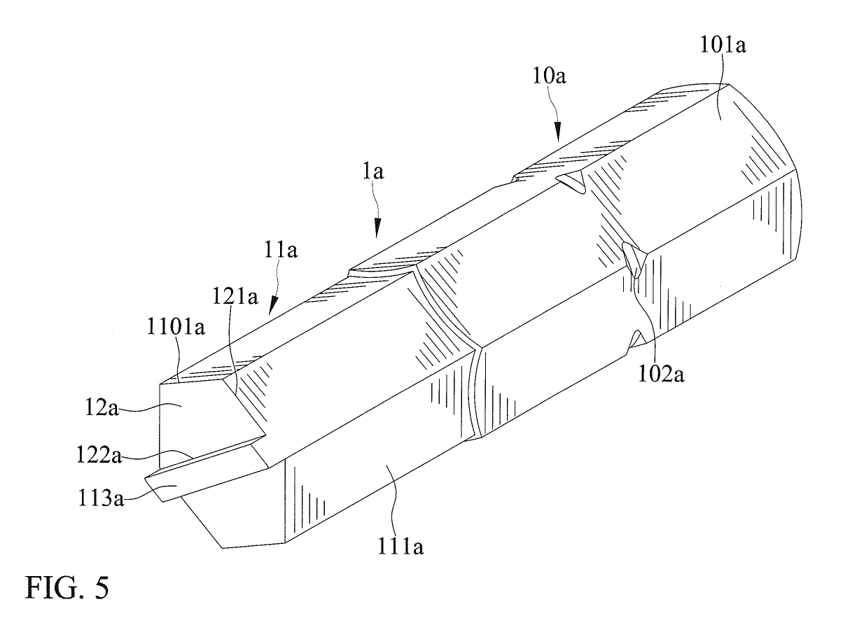

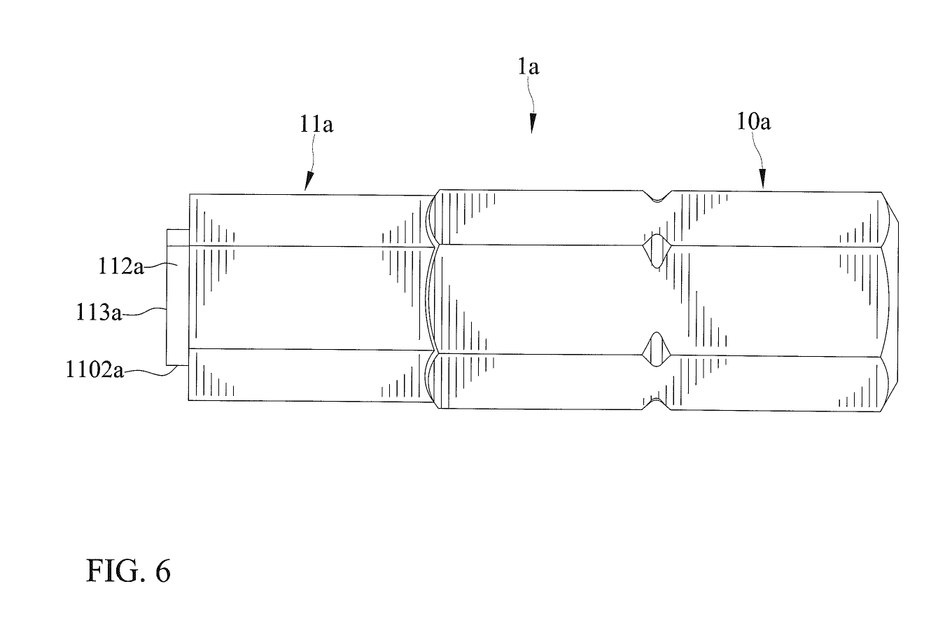

FIGS. 5 and 6 show an anti-slip fastener driver 1a in accordance with a second embodiment of the present invention, and the same numbers are used to correlate similar components of the first embodiment, but bearing a letter a. The anti-slip fastener driver 1a is applied in a screw bit. The anti-slip fastener driver 1a includes a body portion 10a and a driving portion 11a. The body portion 10a includes six outer walls 101a. The driving portion 11a is formed at one terminal end of the body portion 10a.

At least one contact face 12a is formed at one distal end of the driving portion 11a opposite to the body portion 10a. The driving portion 11a includes at least one peripheral face 111. The at least one contact face 12a is at a first included angle 90 degrees to the at least one peripheral face. The at least one contact face 12a include two contact faces 12a. The driving portion 11a includes two driving sections 1101a and a middle section 1102a arranged between the two driving sections 1101a. Each driving section 1101a has three peripheral faces 111a. The driving portion 11a includes an outer periphery thereof defined by six peripheral faces of the two driving sections 1101a. Two proximal faces 112a are respectively formed in two opposite sides of the middle section 1102a. The middle section 1102a forms a protrusion and extends away from the two contact faces 12a to the distal end of the driving portion 11. One end of each driving section 1101a opposite to the body portion 10a forms the contact face 12a. One end of the middle section 1102a opposite to the body portion 10a has a spaced face 113a. The two contact faces 12a and the spaced face 113a form an end face of the distal end of the driving portion 11a together. Each of the two contact faces 12a is flat and is at the first included angle equaling to 90 degrees to one of the three peripheral faces of each driving section 1101a. The spaced face 113a is flat and is perpendicular to one of the peripheral faces 111a of one of the driving section 1101a. Each of the two contact faces 12a includes three short sides 121a respectively connecting with the three peripheral faces 111a of each driving section 1101a, and a long side 122a connecting with one of the proximal faces 112a of the middle section 1102a. The long side 122a of each contact face 12a and each side of the middle section 1102a form a second included angle at 90 degrees.

The two contact faces 12a and the spaced face 113a are parallel to one another.

The spaced face 113a is located at a first height with respect to one of the contact faces 12a and at a second height with respect to the other of the contact faces 12a. The first height equals to the second height, but not limited thereto.

The body portion 10a extends from a first distal end of the anti-slip fastener driver 1a to the driving portion 11a in a first lengthwise direction and the driving portion 11a extends from the body portion 10a to the second distal end of the anti-slip fastener driver 1a in a second lengthwise direction. The first lengthwise direction is axial to the second lengthwise direction. The body portion 10a includes six outer walls 101a and a plurality of slots 102a each formed between every two adjacent outer walls 101a.

In view of the forgoing, it is an object of the present invention to provide an anti-slip fastener driver 1 or 1a adapted for driving a damaged or stripped fastener 2.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. An anti-slip fastener driver comprising:
a body portion; and
a driving portion formed at one terminal end of the body portion and including at least one peripheral face, with at least one contact face formed at one distal end of the driving portion opposite to the body portion, with the at least one contact face being at a first included angle 90 degrees to the at least one peripheral face, with the at least one contact face including two contact faces, with the driving portion including two driving sections and a middle section arranged between the two driving sections, with each driving section having three peripheral faces, with two proximal faces respectively formed in two opposite sides of the middle section, with one end of each driving section opposite to the body portion forming the contact face, with one end of the middle section opposite to the body portion having a spaced face, with the two contact faces and the spaced face forming an end face of the distal end of the driving portion together, with each of the two contact faces being flat and at the first included angle equal to 90 degrees to one of the three peripheral faces of each driving section, with the spaced face being flat and perpendicular to one of the peripheral faces of one of the driving section, with each of the two contact faces including three short sides respectively connecting with the three peripheral faces of each driving section, and a long side connecting with one of the proximal faces of the middle section, and with the long side of each contact face and each side of the middle section forming a second included angle at 90 degrees.

2. The anti-slip fastener driver as claimed in claim 1, wherein the middle section forms a protrusion and extends away from the two contact faces to the distal end of the driving portion.

3. The anti-slip fastener driver as claimed in claim 2, wherein the spaced face located at a first height with respect to one of the contact faces and at a second height with respect to the other of the contact faces.

4. The anti-slip fastener driver as claimed in claim 3, wherein the first height equals to the second height.

5. The anti-slip fastener driver as claimed in claim 1, wherein the body portion extends from a first distal end of the anti-slip fastener driver to the driving portion in a first lengthwise direction and the driving portion extends from the body portion to the second distal end of the anti-slip fastener driver in a second lengthwise direction, and wherein the first lengthwise direction is angled and not axial to the second lengthwise direction.

6. The anti-slip fastener driver as claimed in claim 5, wherein the middle section has a first end, a second end, and a longitudinal length extending from the first end to the second end thereof, and wherein the middle section includes the longitudinal length thereof extending from one of the three short sides towards the first distal end of the body portion to another of the three short sides of the related contact face.

7. The anti-slip fastener driver as claimed in claim 1, wherein the body portion extends from a first distal end of the anti-slip fastener driver to the driving portion in a first lengthwise direction and the driving portion extends from the body portion to the second distal end of the anti-slip fastener driver in a second lengthwise direction, and wherein the first lengthwise direction is axial to the second lengthwise direction.

8. The anti-slip fastener driver as claimed in claim 1, with the body portion including six outer walls, with a plurality of slots each formed between every two adjacent outer walls.

9. The anti-slip fastener driver as claimed in claim 1, wherein the two contact faces and the spaced face are parallel to one another.
